(19) United States
(12) Patent Application Publication
(10) Pub. No.: US 2008/0177982 A1
(43) Pub. Date: Jul. 24, 2008

(54) Memory And Accessing Method Thereof

(75) Inventors: Chuen-An Lin, Hsinchu County (TW); Ching-Tsung Tung, Taipei County (TW)

Correspondence Address: WPAT, PC, 7225 BEVERLY ST., ANNANDALE, VA, 22003, US

(73) Assignee: HOLTEK SEMICONDUCTOR INC., Hsinchu (TW)

(21) Appl. No.: 11/757,488

(22) Filed: Jun. 4, 2007

(30) Foreign Application Priority Data
Jan. 19, 2007 (TW) 096102108

(51) Int. Cl. G06F 9/30; G06F 12/00

(52) U.S. Cl. 712/212; 711/103; 712/E09.011; 711/E12.001

(57) ABSTRACT

The present invention provides a memory device and a method for accessing the memory device thereof. The memory device comprises an address encoding selector for selecting one of plurality of encoding circuits which encodes a first address into a second address, and a data decoding selector for selecting one of plurality of decoding circuits which decodes a first data corresponding to the second address into a second data and a non-volatile memory, coupled to address encoding selector and the data decoding selector, for storing the first data. The method for accessing the memory device comprises encoding a first address into a second address by an address encoding selector, and decoding a first data corresponding to the second address into a second data by a data decoding selector, wherein the first data being stored in the non-volatile memory.

### BACKGROUND OF THE INVENTION

1. Field of the Invention

The invention relates to a memory device and a method for accessing the memory device, and more particularly to a memory device and a method for accessing the memory device with high security to protect data information stored in the memory device.

2. Description of the Related Art

The trend of recent semiconductor device developing is that high density non-volatile memory has been expected to replace some part of the huge external storage device market of computers, because of large storage and low power dissipation. However, data, software, computer program or high confidential information stored in the non-volatile memory, for example, read-only memory (ROM), may be stolen easily by some kinds of method. The method usually is so called “Chip De-cap” or “Dump ROM Code”. The technology of Chip De-cap comprises removing the package of chip and probing the particular data pins for the data information stored in the memory. The technology of Dump ROM Code comprises issuing an instruction to retrieve binary code via I/O ports and reversing binary code to assembly code by a revering program.

In other word, security of the non-volatile memory is desired for each one company/user. Also, it is trend to design a memory device with high security in memory industry.

### BRIEF SUMMARY OF THE INVENTION

The present invention provides a memory device. An exemplary embodiment of the memory device comprises an address encoding selector for selecting one of plurality of encoding circuits which encodes a first address into a second address, a data decoding selector for selecting one of plurality of decoding circuits which decodes a first data corresponding to the second address into a second data and a non-volatile memory, coupled to the address encoding selector and the data decoding selector, for storing the first data.

The present invention also provides another memory device. An exemplary embodiment of the memory device comprises an address encoding selector for selecting one of plurality of encoding circuits which encodes a first address into a second address, the encoding circuits having N types of encoding functions, a data decoding selector for selecting one of plurality of decoding circuits which decodes a first data corresponding to the second address into a second data, the decoding circuits having M types of decoding functions and a non-volatile memory, coupled to the address encoding selector and the data decoding selector, for storing the first data; wherein the non-volatile memory being a read-only memory (ROM).

A method for accessing the memory device is also provided. An exemplary embodiment of the method comprises the following steps. Encoding a first address into a second address by an address encoding selector, and decoding a first data corresponding to the second address into a second data by a data decoding selector, wherein the first data being stored in the non-volatile memory.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a memory device according to the present invention;

FIG. 2 is a block diagram of an address encoding selector shown in the FIG. 1 of an embodiment according to the present invention;

FIG. 3 is a block diagram of a data decoding selector shown in the FIG. 1 of an embodiment according to the present invention;

FIG. 4 is a block diagram of an address encoding selector shown in the FIG. 1 of another embodiment according to the present invention;

FIG. 5 is a block diagram of a data decoding selector shown in the FIG. 1 of another embodiment according to the present invention;

FIG. 6 is a schematic diagram of relation between data and address before encoding;

FIG. 7 is a schematic diagram of relation between address and encoded address of an embodiment according to the present invention;

FIG. 8 is a schematic diagram of relation between encoded address and data of an embodiment according to the present invention;

FIG. 9 is a schematic diagram of relation between data and encoded data of an embodiment according to the present invention;

FIG. 10 is a schematic diagram of relation between encoded data and encoded address;

FIG. 11 is a block diagram of an address encoding selector having one real encoder and fake encoders of another embodiment according to the present invention;

FIG. 12 is a schematic diagram of fake encoders shown in FIG. 11 of an embodiment according to the present invention;

FIG. 13 a block diagram of a data decoding selector having one real decoder and fake decoders of another embodiment according to the present invention;

FIG. 14 is a schematic diagram of 1^{st} fake decoder shown in FIG. 13 of an embodiment according to the present invention;

FIG. 15 is a schematic diagram of 2^{nd} fake decoder shown in FIG. 13 of an embodiment according to the present invention;

FIG. 16 is a schematic diagram of 3^{rd} fake decoder shown in FIG. 13 of an embodiment according to the present invention; and

FIG. 17 is a schematic diagram of encryption file of an embodiment according to the present invention.

### DETAILED DESCRIPTION OF THE INVENTION

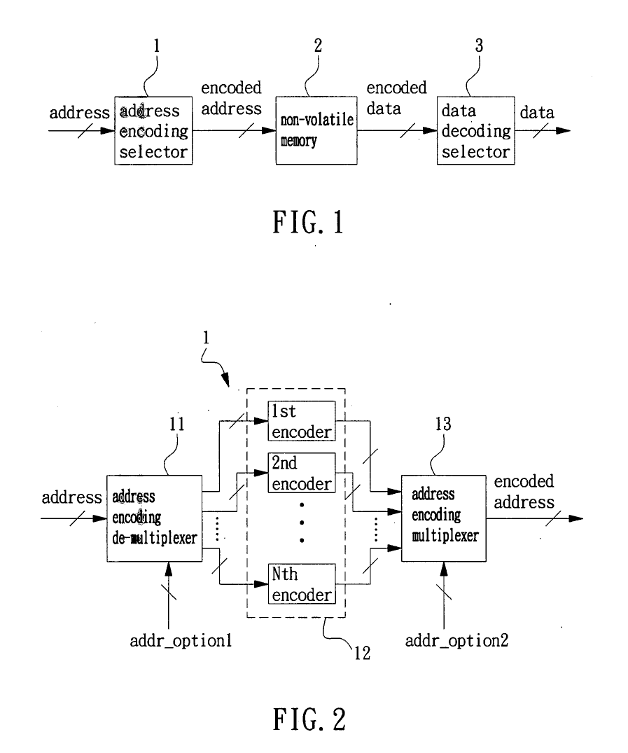

Several exemplary embodiments of the invention are described with reference to FIGS. 1 through 17, which generally relate to a memory device with high security to protect data information. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a memory device and a method for accessing the memory device.

Referring to FIG. 1, it is a block diagram of a memory device according to the present invention.

The memory device comprises an address encoding selector 1, a non-volatile memory 2, for example, read-only memory, and a data decoding selector 3. The non-volatile memory 2 coupled to the address encoding selector 1 and the data decoding selector 3. The address encoding selector 1 receives an address (first address) provided by a software address generator (not shown) and transmits an encoded address (second address) provided by a software data generator to the non-volatile memory 2. An encoded data (first data) corresponding to the encoded address is received by the data decoding selector 3 and a data (second data) is output from the data decoding selector 3.

In addition to read-only memory, the non-volatile memory 2 may be a mask programmable read-only memory (mask ROM), an electrically erasable programmable read-only memory (EEPROM), an erasable programmable read-only memory (EPROM) or a flash programmable read-only memory (Flash ROM).

Referring to FIG. 2, it is a block diagram of an address encoding selector shown in the FIG. 1 of an embodiment according to the present invention.

The address encoding selector 1 comprises an address encoding de-multiplexer 11, a plurality of encoding circuits 12 (1^{st} encoder, 2^{nd} encoder . . . N^{th} encoder) and an address encoding multiplexer 13. The address encoding de-multiplexer 11 directs address to one of the encoding circuits 12 by a selection signal Addr_option1. In the other hand, the address encoding multiplexer 13 outputs encoded address by a selection signal Addr_option2 selecting the output of one of the encoding circuits 12.

It is noted that each one of the encoding circuits 12 may has a special/different encoding function. Thus, plurality of encoding circuits 12 may have N encoding functions for encoding address. Furthermore, the possibility of correctly providing the encoded address to the non-volatile memory 2 is 1/N² when there is no correlation between the signal Addr_option1 and the signal Addr_option2.

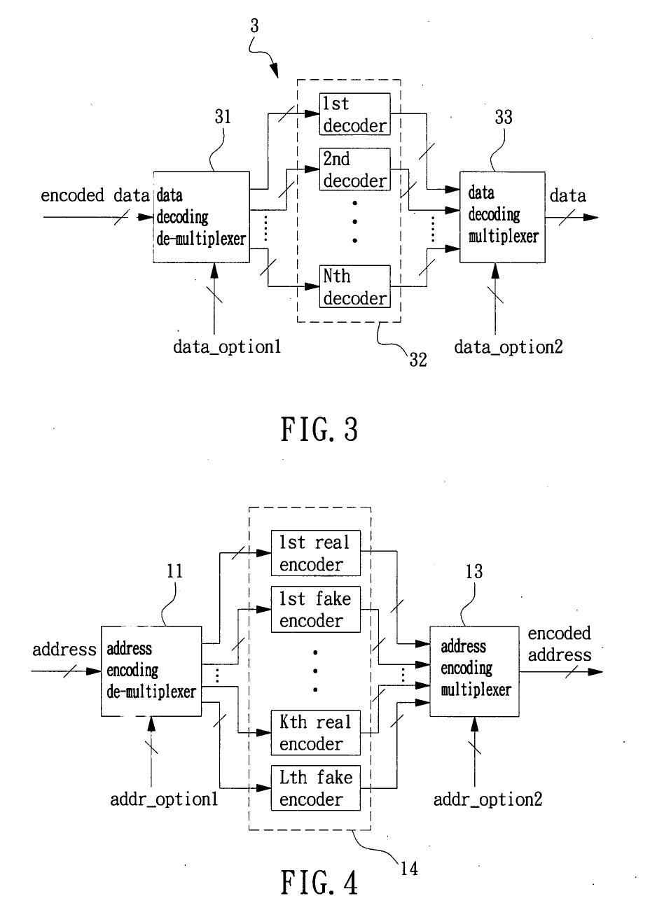

Referring to FIG. 3, it is a block diagram of a data decoding selector shown in the FIG. 1 of an embodiment according to the present invention.

The data decoding selector 3 comprises a data decoding de-multiplexer 31, a plurality of decoding circuits 32 (1^{st} decoder, 2^{nd} decoder . . . M^{th} decoder) and a data decoding multiplexer 33. The data decoding de-multiplexer 31 directs encoded data to one of the decoding circuits 32 by a selection signal Data_option1. In the other hand, the data decoding multiplexer 33 outputs data by a selection signal Data_option2 for selecting the output of one of the decoding circuits 32.

It is noted that each one of the decoding circuits 32 may has a special/different decoding function. Thus, plurality of decoding circuits 32 may have M decoding functions for decoding data. Moreover, the possibility of correctly outputting the data is 1/M² when there is no correlation between the signal Data_option1 and the signal Data_option2.

According to FIG. 2 and FIG. 3, it is found that data information stored in the non-volatile memory is very safe when a user with bad intention but without Addr_option1, Addr₋option2, Data_option1 and Data_option2. The possibility of retrieving data information is 1/(N²*M²).

Referring to FIG. 4, it is a block diagram of an address encoding selector shown in the FIG. 1 of another embodiment according to the present invention.

The address encoding de-multiplexer 11 and the address encoding multiplexer 13 are the same as that shown in FIG. 2. It is noted that the encoding circuits 14 comprise a plurality of real encoders (1^{st} real encoder . . . K^{th} real encoder) and a plurality of fake encoders (1^{st} fake encoder . . . L^{th} fake encoder). The real encoders have real encoding functions for encoding address, but the fake encoders have wrong encoding functions for increasing complexity of selection signals Addr_option1 and Addr_option2.

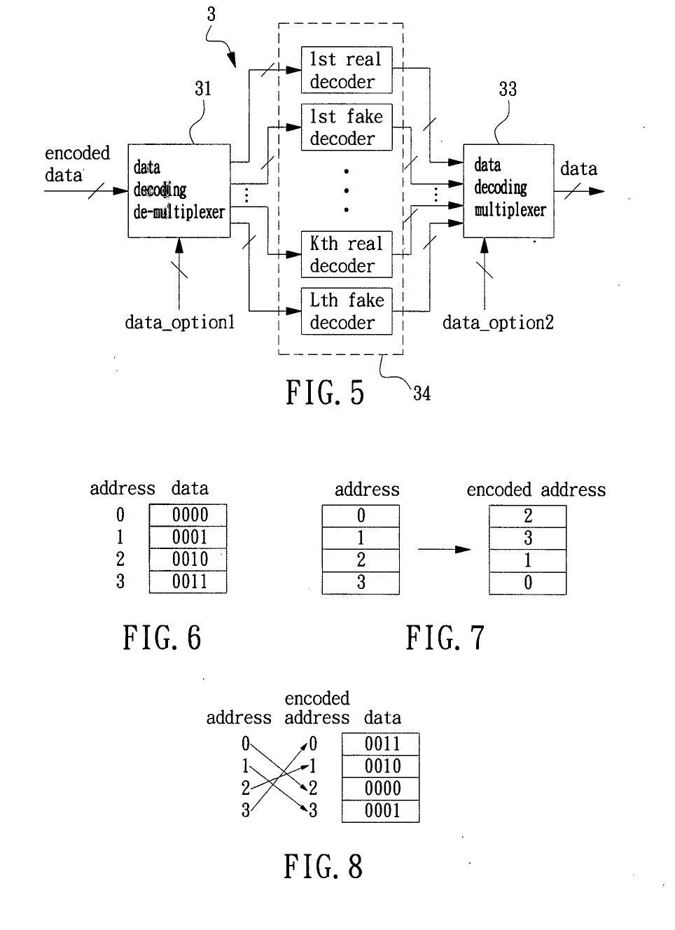

Referring to FIG. 5, it is a block diagram of a data decoding selector shown in the FIG. 1 of another embodiment according to the present invention.

The data decoding de-multiplexer 31 and the data decoding multiplexer 33 are the same as that shown in FIG. 3. It is noted that the decoding circuits 34 comprise a plurality of real decoders (1^{st} real decoder . . . K^{th} real encoder) and a plurality of fake decoders (1^{st} fake decoder . . . L^{th} fake decoder). The real decoders have real decoding functions for decoding encoded data, but the fake decoders have wrong decoding functions for increasing complexity of selection signals Data_option1 and Data_option2.

Referring to FIG. 6, it is a schematic diagram of relation between data and address before encoding.

For example, capacity of the non-volatile memory is 4×4 bits, the decimal address starts from 0 to 3, and binary data 0000, 0001, 0010, 0011 stored in the non- volatile memory. It is found that the decimal address 0 corresponds to binary data 0000, the decimal address 1 corresponds to binary data 0001, the decimal address 2 corresponds to binary data 0010 and the decimal address 3 corresponds to binary data 0011 before encoding.

FIG. 7 is a schematic diagram of relation between address and encoded address of an embodiment according to the present invention.

Now, the decimal address 0 is encoded into 2, the decimal address 1 is encoded into 3, the decimal address 2 is encoded into 1 and the decimal address 3 is encoded into 0.

Referring to FIG. 8, it is a schematic diagram of relation between encoded address and data of an embodiment according to the present invention.

It is found that the encoded decimal address 2 (decimal address 0) still corresponds to the binary data 0000, the relationship is not changed. Also, the encoded decimal address 3 (decimal address 1) still corresponds to the binary data 0001. The encoded decimal address 1 (decimal address 2) still corresponds to the binary data 0010 and the encoded decimal address 0 (decimal address 3) still corresponds to the binary data 0011.

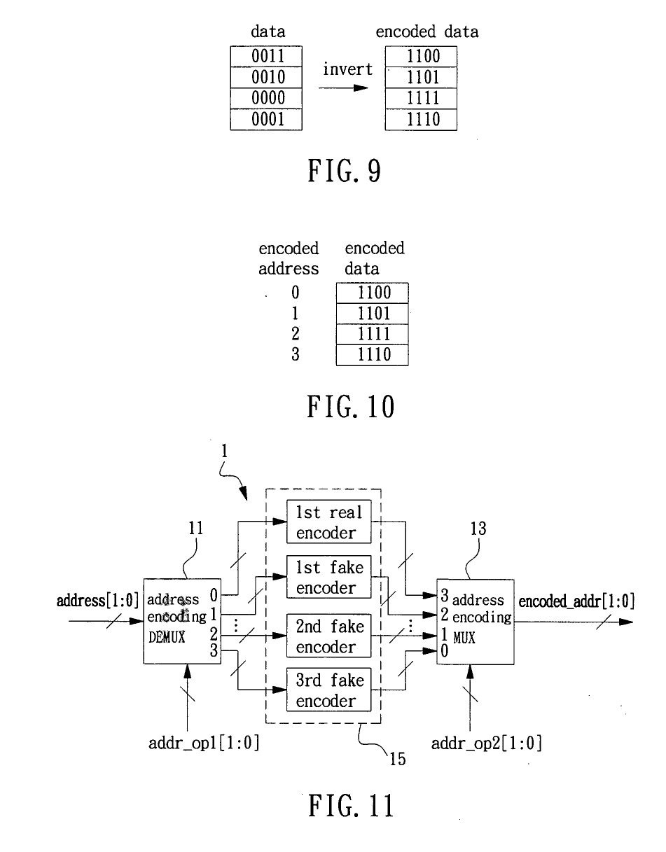

Referring to FIG. 9, it is a schematic diagram of relation between data and encoded data of an embodiment according to the present invention.

Now, the binary data 0011 is encoded to, for example, the complement 1100 as encoded binary data. The binary data 0010 is encoded to 1101, the binary data 0000 is encoded to 1111 and the binary data 0001 is encoded to 1110.

Referring to FIG. 10, it is a schematic diagram of relation between encoded data and encoded address.

It is found that the encoded decimal address 0 corresponds to encoded binary data 1100, the encoded decimal address 1 corresponds to encoded binary data 1101, the encoded decimal address 2 corresponds to encoded binary data 1111 and the encoded decimal address 3 corresponds to encoded binary data 1110. The relationship between decimal address and binary data is the same as the relationship between encoded decimal address and encoded binary data. According to FIG. 6 to FIG. 10, the programmer/designer/user could store his program, software or confidential document by this way in advance.

Referring to FIG. 11, it is a block diagram of an address encoding selector having one real encoder and fake encoders of another embodiment according to the present invention.

The encoding circuits 15 comprises a real encoder (1^{st} real encoder) and three fake encoders (1^{st} fake encoder, 2^{nd} fake encoder and 3^{rd} fake encoder), wherein the 1^{st} real encoder performs encoding function as described in the FIG. 7. For example, the address encoding de-multiplexer 11 receives address[1:0]=0, directs address[1:0] to the 1^{st} real encoder by the selection signal addr_op1 [1:0] for encoding 0 to 2 (as shown in FIG. 7). Then, the address encoding multiplexer 13 selects the 3^{rd} input by the selection signal addr_op2[1:0] and outputs the encoded_addr[1:0]=2 to the non-volatile memory. Consequently, the encoded binary data 1111 corresponding to the encoded_addr[1 :0] =2 is transmitted to the data decoding selector 3. Regarding to operation of the data decoding selector 3, it is described later in FIG. 13.

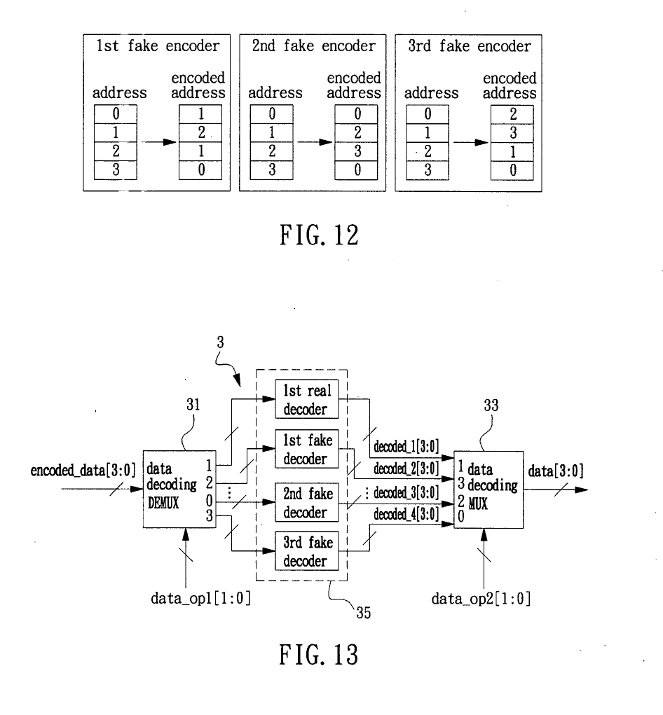

Referring to FIG. 12, it is a schematic diagram of fake encoders shown in FIG. 11 of an embodiment according to the present invention.

The fake encoders may be implemented as FIG. 12. For example, the 1^{st} fake encoder encodes the decimal address 0 to 1 and also encodes the decimal address 2 to 1. It makes different address become the same encoded address. In particular, the 3^{rd} fake encoder encodes every decimal address (0, 1, 2 and 3) to decimal encoded address 0.

Referring to FIG. 13, it is a block diagram of a data decoding selector having one real decoder and fake decoders of another embodiment according to the present invention.

The decoding circuits 35 comprises a real decoder (1^{st} real decoder) and three fake decoders (1^{st} fake decoder, 2^{nd} fake decoder and 3^{rd} fake decoder), wherein the 1^{st} real decoder performs decoding function as described in the FIG. 9. Following by description of FIG.11, the data decoding de-multiplexer 31 receives the encoded-data[3:0]=1111 and directs it to the 1^{st} real decoder by the selection signal data_op1[1:0] for decoding 1111 to 0000 (complement of 1111). Then, the data decoding multiplexer 33 selects the 1^{st} input (decoded_1 [3:0]=0000) by the selection signal data_op2[1:0] and outputs the data[3:0]=0000. Data[3:0]=0000 may be an instruction “Fetch” after decoded by an instruction decoder (not shown).

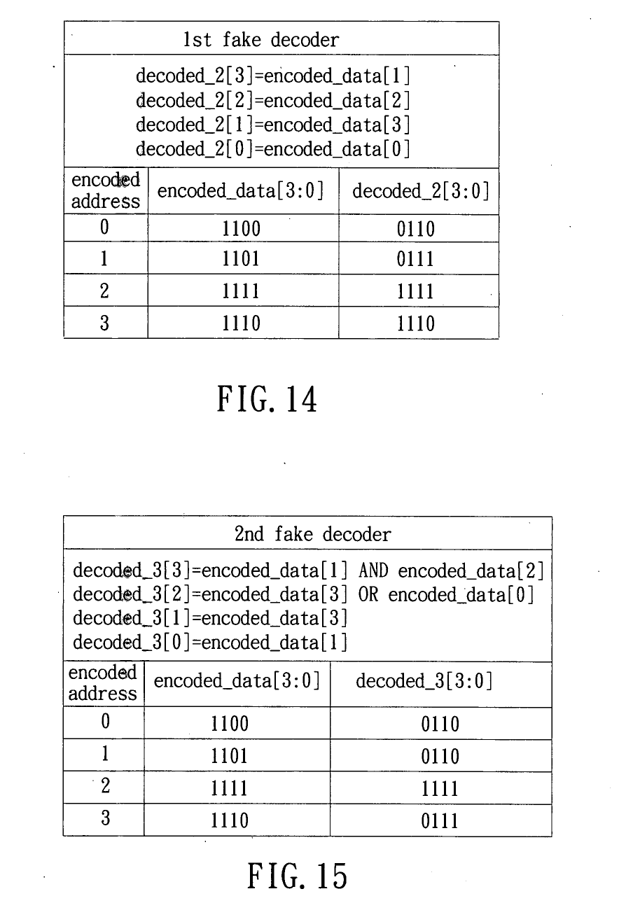

Referring to FIG. 14, it is a schematic diagram of 1^{st} fake decoder shown in FIG. 13 of an embodiment according to the present invention.

The 1^{st} fake decoder decodes 1100 to 0110, 1101 to 0111, 1111 to 1111 and 1110 to 1110. Following by description of FIG. 13, data[3:0]=1111 (or said decoded_2[3:0]=1111) can not be an instruction “Fetch” after decoded by an instruction decoder (not shown).

Referring to FIG. 15, it is a schematic diagram of 2^{nd} fake decoder shown in FIG. 13 of an embodiment according to the present invention.

The 2^{nd} fake decoder decodes 1100 to 0110, 1101 to 0110, 1111 to 1111 and 1110 to 0111. Following by description of FIG. 13, data[3:0]=1111 (or said decoded_2[3:0]=1111) can not be an instruction “Fetch” after decoded by an instruction decoder (not shown).

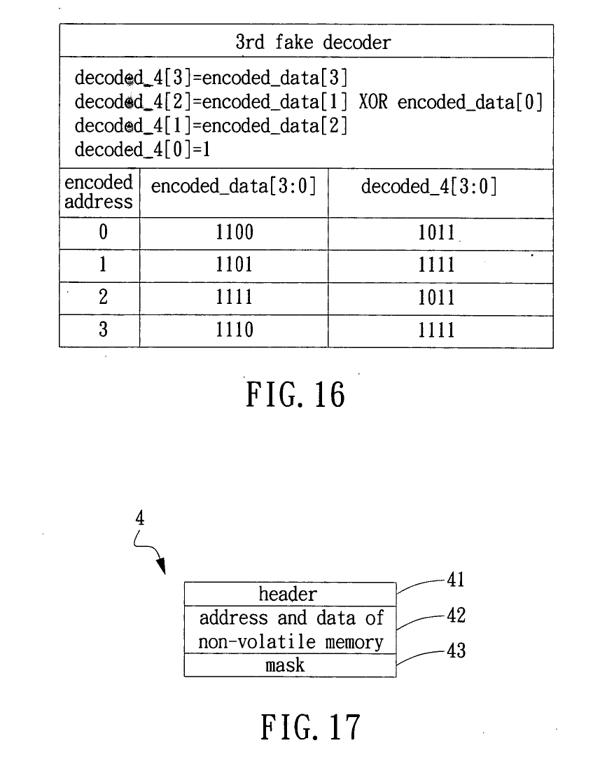

Referring to FIG. 16, it is a schematic diagram of 3^{rd} fake decoder shown in FIG. 13 of an embodiment according to the present invention.

The 3^{rd} fake decoder decodes 1100 to 1011, 1101 to 1111, 1111 to 1011 and 1110 to 1111. Following by description of FIG. 13, data[3:0]=1011 (or said decoded_2[3:0]=1011) can not be an instruction “Fetch” after decoded by an instruction decoder (not shown).

Referring to FIG. 17, it is a schematic diagram of encryption file of an embodiment according to the present invention.

The encryption file 4 generated by a software comprises a header 41, address and data of non-volatile memory 42 and a mask 43. The header 41 comprises type of the software, encoding function for address and decoding function for data. The address and data of non-volatile memory 42 is so called ROM code. The mask 43 comprises information about addr_op1, addr_op2, data_op1 and data_op2.

The mask 43 may be implemented by transistor circuits which is similar to a switch. It could be a part of Place and Route (P&R). The process of Place and Route comprises Floor Planning, Placement and Routing. Designers could arrange the mask everywhere he wants in the P&R to confuse copiers.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A memory device, comprising:
an address encoding selector for selecting one of plurality of encoding circuits which encodes a first address into a second address;
a data decoding selector for selecting one of plurality of decoding circuits which decodes a first data corresponding to the second address into a second data; and
a non-volatile memory, coupled to the address encoding selector and the data decoding selector, for storing the first data.

2. The memory device as claimed in claim 1, wherein the non-volatile memory is selected form a group consisting of a mask programmable read-only memory, a mask ROM, an electrically erasable programmable read-only memory (EEPROM), an erasable programmable read-only memory (EPROM), and a flash programmable read-only memory (Flash ROM).

3. The memory device as claimed in claim 1, wherein the encoding circuits comprise N types of encoding functions.

4. The memory device as claimed in claim 1, wherein the decoding circuits comprise M types of decoding functions.

5. The memory device as claimed in claim 1, wherein the first address being provided by a software address generator.

6. The memory device as claimed in claim 5, wherein the software address generator generates an encryption file in a format comprising a header, an address and a mask.

7. The memory device as claimed in claim 1, wherein the first data being provided by a software data generator.

8. The memory device as claimed in claim 7, wherein the software data generator generates an encryption file in a format comprising a header, an address and a mask.

9. The memory device as claimed in claim 1, wherein the address encoding selector further comprises an address encoding multiplexer and an address encoding de-multiplexer.

10. The memory device as claimed in claim 1, wherein the data decoding selector further comprises a data decoding multiplexer and a data decoding de-multiplexer.

11. The memory device as claimed in claim 1, wherein the address encoding selector further comprises a plurality of real encoders and a plurality of fake encoders.

12. The memory device as claimed in claim 1, wherein the data decoding selector further comprises a plurality of real decoders and a plurality of fake decoders.

13. The memory device as claimed in claim 1, the second data being decoded by an instruction decoder.

14. A memory device, comprising:
an address encoding selector for selecting one of plurality of encoding circuits which encodes a first address into a second address, the encoding circuits having N types of encoding functions;
a data decoding selector for selecting one of plurality of decoding circuits which decodes a first data corresponding to the second address into a second data, the decoding circuits having M types of decoding functions; and
a non-volatile memory, coupled to the address encoding selector and the data decoding selector, for storing the first data; wherein the non-volatile memory being a read-only memory (ROM).

15. A method for accessing a memory device, comprising:
encoding a first address into a second address by an address encoding selector; and
decoding a first data corresponding to the second address into a second data by a data decoding selector; wherein the first data being stored in a non-volatile memory.

16. The method for accessing a memory device as claimed in claim 15, wherein the address encoding selector comprises a plurality of real encoders and a plurality of fake encoders.

17. The method for accessing a memory device as claimed in claim 15, wherein the data decoding selector comprises a plurality of real decoders and a plurality of fake decoders.
